(19) United States
(12) Patent Application Publication
(10) Pub. No.: US 2005/0007303 A1
(43) Pub. Date: Jan. 13, 2005

(54) Small screen larger than life 3D TV

(76) Inventor: Ernest Betton, Mount Rainier, MD (US)

Correspondence Address: ERNEST BETTON;C/O TIMOTHY ELBERT BETTON, 4301 EASTERN AVENUE #4, MOUNT RAINIER, MD, 20712, US

(21) Appl. No.: 10/460,253

(22) Filed: Jun. 13, 2003

(51) Int. Cl. G09G 5/00

(52) U.S. Cl. 345/8

(57) ABSTRACT

A Small Screen Larger than Life 3D TV (Disclosure Document #516819) is an original concept of what is now conventionally known as Virtual Reality. By use of the Head Set device and the Hand Set Control device, one is able to view 3D imagery, reacting interactively with the cinematic progression of scenes, conditions, and events. It will allow the User the impression of being an active part of the cinematic progression instead of as a mere spectator. An addition to the original concept (DDN 516819) is the Scent Unit, which will enhance the cinematic experience by creating scents that would naturally occur in normal surroundings, conditions, and environments. By adding this component of olfactory sensation to the original invention, this will truly revolutionize the way Virtual Reality is enjoyed and utilized.

FIG. 1A is a frontal view of A Small Screen Larger Then Life 3D TV Head Set Unit, replete with top support head strap, which connects to a back support head strap, showing my original design as documented under Disclosure Document #516819. FIG. 1B is a back view thereof: displaying the original four sockets from my original design with the addition of two sockets, the Computer socket located on the back, middle left side and the Scent Unit socket located on the back, middle right side of the Head Set Unit. Head straps are not shown in order to facilitate view.

FIG. 2 is a left side view thereof: showing from top to bottom, the VCR socket, the Computer socket, and the Cable socket. The right side view is identical with three identical sockets with the exception of the purpose of those sockets from top to bottom: the Hand Set Control Cable socket, the Scent Unit socket, and the Hand Set Control Unit Power Cable socket.

FIG. 3A is a top view thereof: displaying the Hand Set Unit, replete with a series of button controls.

FIG. 3B is a bottom view thereof: displaying the Hand Set Unit, replete with designated power jacks which connect directly to the sockets in the Head Set Unit.

FIG. 4A is a frontal view thereof: displaying the first of three parts that make up the Scent Unit. It is called the Scent Unit Chamber.

FIG. 4B is a frontal view thereof: displaying the second of three parts that make up the Scent Unit. This portion contains the heat and vibration prongs that will be housed by the Scent Unit Chamber.

FIG. 5 is a frontal view thereof: displaying the third of three parts that make up the Scent Unit. When joining FIG. 4A to FIG. 4B together, this resulting apparatus can then be connected to FIG. 5, which is called the Initiator.

FIG. 6 is a side view thereof: displaying a fully constructed Scent Unit.

FIG. 7 is a frontal view thereof: displaying a fully constructed Scent Unit. This Scent Unit is an addition to my original concept design as documented under Disclosure Document # 516819.

I claim: the ornamental design for A Small Screen Larger than Life 3D TV as shown.

This invention is an original concept filed under Document Disclosure # 516819. This invention was originally called A Small Screen Larger Than Life 3D TV. This original concept and prototype is now well known as the model, which produces interactive panoramic 3D cinematic progression called Virtual Reality. This original concept was conceived exactly for the purpose Virtual Reality is now used.

Invention (Disclosure Document # 516819) is a model composed of a Head Set Unit and a Hand Set Control Unit. The Head Set Unit is a visor-like apparatus that fits comfortably over the head. The portion that covers the eyes will fit securely over the contours of the face, similar to a soft, synthetic mesh. There is a strap that runs from the front of the Head Set Unit to the back of the head, attaching to a strap that runs laterally across the back of the head. This will afford usage for most head sizes.

The Head Set Unit is replete with a series of sockets for various functions in relation to external connections such as computers and VCRs and to the operation of the model such as the Hand Set Control Unit.

The Hand Set Control Unit is a component of the model that connects directly to the Head Set Unit via cables with jacks for the sockets in the Head Set Unit. The top portion of the Hand Set Control Unit contains the operational aspects such as buttons for use of the invention. The back portion of the Hand Set Control Unit contains power source connections such as the Controls Outlet Jack and the AC/DC Power Outlet.

The model will produce a panoramic 3D cinematic progression that will give the User the visual impression of interaction with a myriad of characters, elements, and conditions that are viewed through the visor. It will be classified for use as an entertainment device to the User to experience full visual enjoyment and as an educational tool to enhance understanding by interactive visual images.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The field of endeavor to which the invention pertained and does pertain is to the enhancement of the visual experience while viewing cinematic progressions, i.e., movies, documentaries, customized visual programs, etc. This concept was originally conceived in 1987 by, myself, Ernest Betton. To my knowledge, and through a consequent patent search, no concept of it's kind existed prior to 1987.

### BRIEF SUMMARY OF THE INVENTION

In summary, the Small Screen Larger than Life 3D TV (Virtual Reality) is a device operated to enhance and enrich the User's cinematic experience. It will revolutionize the way two-dimensional images are perceived on television and in movie theatres. Through third dimensional imagery, with a panoramic view of all images, this device allows the User the impression of interaction with these images and conditions. The modern concept of Virtual Reality in the intended use was actually the intended purpose and usage that was originally explained in the description of the concept back in 1987 (Disclosure Document # 516819).

### BRIEF DESCRIPTION OF THE SEVERAL VIEWS OF THE DRAWING

FIG. 1A is a frontal view of A Small Screen Larger Then Life 3D TV Head Set Unit, replete with top support head strap, which connects to a back support head strap, showing my original design as documented under Disclosure Document #516819.

FIG. 1B is a back view thereof: displaying the original four sockets from my original design with the addition of two sockets, the Computer socket located on the back, middle left side and the Scent Unit socket located on the back, middle right side of the Head Set Unit. Head straps are not shown in order to facilitate view.

FIG. 2 is a left side view thereof: showing from top to bottom, the VCR socket, the Computer socket, and the Cable socket. The right side view is identical with three identical sockets with the exception of the purpose of those sockets from top to bottom: the Hand Set Control Cable socket, the Scent Unit socket, and the Hand Set Control Unit Power Cable socket.

FIG. 3A is a top view thereof: displaying the Hand Set Unit, replete with a series of button controls.

FIG. 3B is a bottom view thereof: displaying the Hand Set Unit, replete with designated power jacks which connect directly to the sockets in the Head Set Unit.

FIG. 4A is a frontal view thereof: displaying the first of three parts that make up the Scent Unit. It is called the Scent Unit Chamber.

FIG. 4B is a frontal view thereof: displaying the second of three parts that make up the Scent Unit. This portion contains the heat and vibration prongs that will be housed by the Scent Unit Chamber. This is the Scent Unit Cartridge Chamber.

FIG. 5 is a frontal view thereof: displaying the third of three parts that make up the Scent Unit. When joining FIG. 4A to FIG. 4B together, this connected component can then be connected to FIG. 5, which is called the Initiator, the third component.

FIG. 6 is a side view thereof: displaying a fully constructed Scent Unit.

FIG. 7 is a frontal view thereof: displaying a fully constructed Scent Unit. This Scent Unit is an addition to my original concept design as documented under Disclosure Document # 516819.

### DETAILED DESCRIPTION OF THE INVENTION

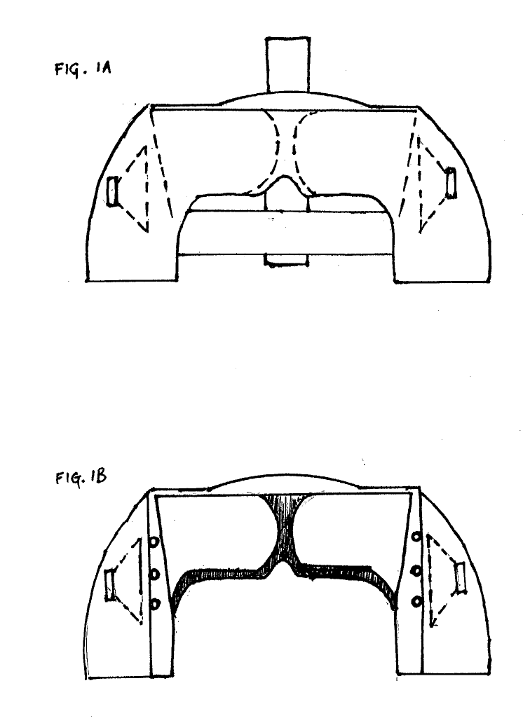

FIG. 1A is a frontal view of the Small Screen Larger than Life 3D TV (Virtual Reality) Head Set Unit. This drawing gives a transparent, frontal view of the left and right speakers for audio in relation to the cinematic progression. The top portion contains the frontal view of the top head strap that runs from the front of the Head Set to the back, which will connect to a back head strap. The back head strap will run laterally across the back of the head. These head straps will be adjustable for most head sizes.

FIG. 1B is a rear view of the Head Set Unit. There are a series of sockets. On the left side of the Head Set, there are located from top to bottom the: VCR Socket, Computer Socket (Unit addition to original concept DDN: 516819), and Cable Socket. Located on the right side from top to bottom is the: Hand Set Control Cable Socket, Scent Unit Socket (Unit addition to original concept DDN: 516819), and Hand Set Control Unit Power Cable Socket.

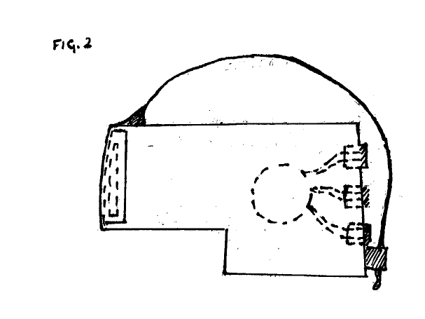

FIG. 2 displays the left side view of the Head Set Unit. The right side view is identical with the exception of the three sockets (right side sockets, see above in FIG. 1B). Common components that both sides contain are the internal Head Set wiring which leads to the Full Eye Screen Monitor with each inbuilt speaker for the left and right ear. The Head Set Unit will also contain an inbuilt antenna (that may be enabled or disabled according to certain connection, i.e., TV, Computer, VCR, etc.), which will operate in conjunction with the internal wiring of the Head Set Unit. The Head Set Unit contains a top head strap which runs from the front to the back which will be connected to a lateral head strap that will run across the back of the head. These durable straps will accommodate most head sizes in conjunction with the Head Set.

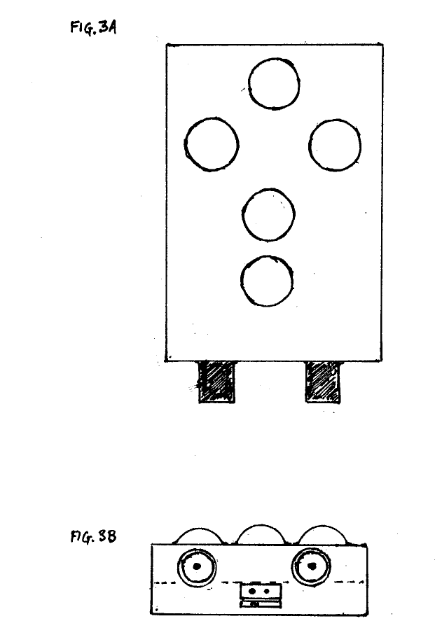

FIG. 3A displays the top view of the Small Screen Larger than Life 3D TV Hand Set Control Unit. From top to bottom or front to back contains: the Channel Button (centered-top), Vertical Switch (left), Horizontal Switch (right), Volume Up/Down Switch (centered-bottom), and the Auto Color Button (centered at very bottom).

FIG. 3B displays the back portion of the Hand Set Control Unit, which contains the Control Outlet Jack (left and right) and the AC/DC Power Outlet (centered bottom). The Hand Set Unit also houses a battery compartment within the bottom portion of the device. The Hand Set Control Unit is connected to the right side of the Head Set Unit via cables with jacks for the sockets in the Head Set Unit.

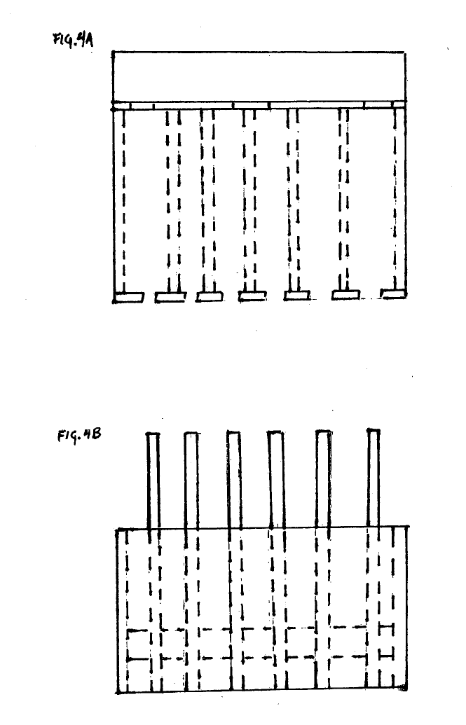

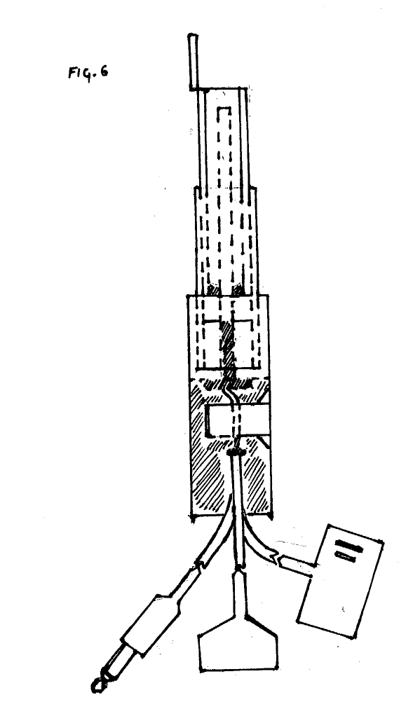

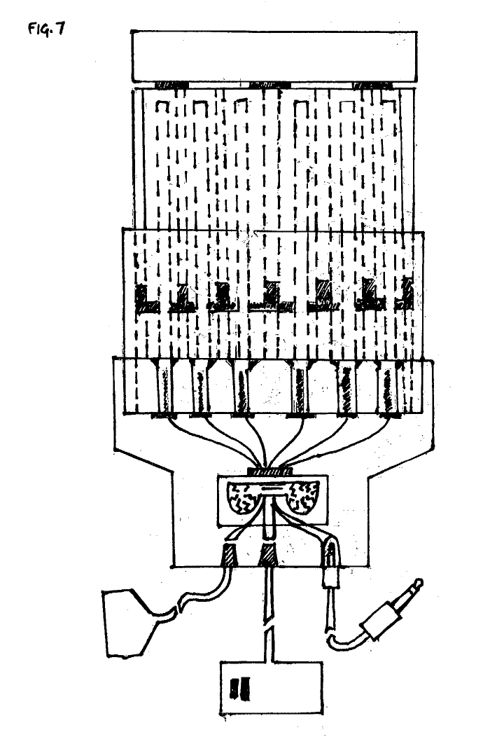

The following drawings: FIGS. 4A, 4B, 5, 6, 7 are an addition to my original concept, which is filed under Disclosure Document #516819. This component is called the Scent Unit and is composed of three distinct parts:

FIG. 4A displays a frontal view of the top-most portion of the Scent Unit, which is called the Scent Unit Chamber. This component contains a perforated, six-compartment chamber made of durable, noncombustible material (ceramic or porcelain), which will house the second part of the Scent Unit. This second part will be explained in detail in FIG. 4B. The Scent Unit Chamber, FIG. 4A will also contain a lid, which will be designed in such a way as to create a hermetic seal.

The Scent Unit Chamber will contain six compartments, which will house the second component of the completed Scent Unit. This middle portion of the Scent Unit or the Scent Unit Cartridge Chamber, FIG. 4B, will contain six well-insulated heat and vibration coils designed to fit securely into the Scent Unit Chamber, FIG. 4A. This second component will house six different scent cartridges with a plethora of chemically safe, embedded scents. These scents will be released synchronously to complement and enhance the reality of the 3D images and a whole host of intangibles, i.e., effects of nature, time, and space.

As explained above, this second component will house the six Scent Cartridges. The actual Scent Cartridges will be shorter in length in relation to the identical lengths of the separate chamber compartments. Activation of the coils in FIG. 4B will originate in the third component of the Scent Unit, which will be explained shortly. As these coils heat and vibrate within the chamber at a modifiable temperature and frequency, respectively, the Scent Cartridges will release scent molecules into the upper portion of the chamber of which it is contained. The scent molecules will diffuse through the perforations creating an ambient plethora of scents and scent combinations, which will be synchronized with the viewed 3D cinematic progression. The lid of the component first mentioned in the Scent Unit Chamber, FIG. 4A, will create a hermetic seal, which will prevent dissipation and preserve the integrity of the components housed within.

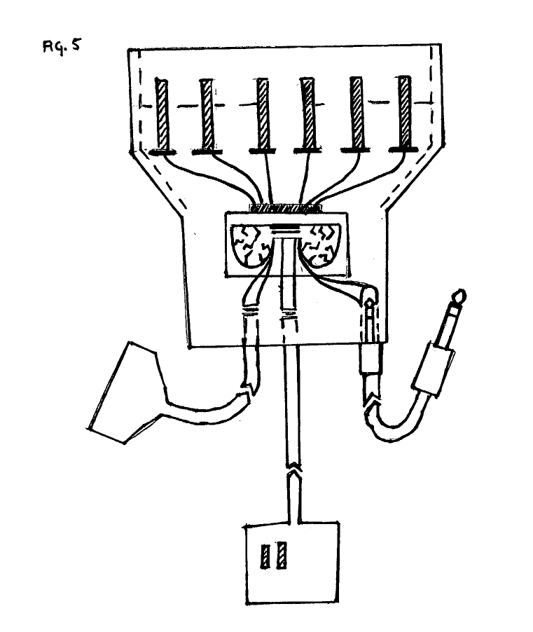

When joining the Scent Unit Chamber, FIG. 4A, together with the Scent Unit Cartridge Chamber, FIG. 4B, this portion of the Scent Unit can then be connected to the third and bottom component of the Scent Unit called the Initiator, which is FIG. 5.

The Initiator, FIG. 5 contains a chamber for the electronics/computer chip(s) that lead into prongs, which are then inserted into the heat and vibration coils. The Initiator contains three cords or cables:
a. TV or Computer cable
b. Power cable with Adapter
c. Cable that connects Unit to the Head Set

The fully assembled Scent Unit Chamber along with the Head Set/Hand Set Control Unit will work together to create and generate a true virtually realistic experience.

As the User views programmed 3D images through the Head Set Unit, i.e., cinema/movies, sports, documentaries, etc., the Initiator will recognize the visual progression through specialized encoding. It will simultaneously process the myriad of visual images, conditions and events, thereby stimulating the prongs. This will, in effect, cause a tempered heating and vibration in the Scent Unit Cartridge Chamber, thereby causing a steady emission of scent and scent combinations, which will be instantly detected by the olfactory sense for added enjoyment.

Some scents will fade while others become more prominent according to the cinematic progression. Some scents will be known as Anchor Scents, which will be the basis of other scents that will be programmed to take precedence from scene to scene. The well-insulated heat and vibration coils will work in synchronicity with every element of cinematic progression, thereby giving the User/Consumer the most indulging VR experience- - - Reality. . . Virtually.

1. What I, Ernest Betton, claim as my invention and an original concept of Virtual Reality is the Head Set Unit, FIG. 1A, FIG. 1B, and FIG. 2 (Small Screen Larger Than Life 3D TV Disclosure Document # 516819, also conventionally known as Virtual Reality). From the original concept, I, Ernest Betton have also derived two additional sockets to the Head Set Unit, of which I claim. They are the Computer Socket (middle socket on the left side) in addition to the VCR socket (top left) and the Cable Socket (bottom left). The right side of the Head Set Unit contains the addition of the Scent Unit Socket (middle socket on the right side) in addition to the Hand Set Cable Socket (top right) and the Hand Set Power Cable Socket (bottom right). This Head Set Unit is to be utilized for the purpose of viewing interactive, three-dimensional imagery, i.e., persons, places, and things in cinematic progression. This Head Set will allow the User to feel the impression of being surrounded by this panoramic view of 3D imagery.

2. What I, Ernest Betton, claim as my invention and original component to the original concept to the Head Set Unit, (Disclosure Document # 516819) is the Hand Set Control Unit, FIGS. 3A and 3B, which will be used for the purpose of controlling the operation of the Head Set Unit. The Hand Set Control Unit will contain the Channel Button, Vertical Switch, Horizontal Switch, Volume Up/Down Switch, and the Auto Color Button. The adjacent/back portion of the Hand Set Control Unit contains the Controls Outlet Jack and the AC/DC Power Outlet, which will be connected via cables to the right side sockets on the Head Set Unit, as mentioned above. A battery compartment will also be housed within the Hand Set Control Unit.

3. What I, Ernest Betton, claim as my invention are the three additional components which make up the Scent Unit in full configuration:
This is an addition to the original claim with noted additions made above. I, Ernest Betton, claim the Scent Unit Chamber, which houses the Scent Unit Cartridge Chamber. I, Ernest Betton, claim the Scent Unit Cartridge Chamber, which is housed by the Scent Unit Chamber. I, Ernest Betton, claim the Initiator and all components contained within the Initiator, which connects to the Scent Unit Cartridge Chamber, which is connected to the Scent Unit Chamber, thereby activating the heat and vibration coils for scent emission of the scent cartridges.
